(19) United States
(12) Patent Application Publication
(10) Pub. No.: US 2007/0202730 A1
(43) Pub. Date: Aug. 30, 2007

(54) Connector and connector fitting structure

(76) Inventors: Kenichi Ikeya, Shizuoka-ken (JP); Nozomi Itou, Tochigi (JP); Takuma Inomata, Tochigi (JP); Ronald Alan Cabangal, Shizuoka-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/702,183

(22) Filed: Feb. 5, 2007

(30) Foreign Application Priority Data
Feb. 6, 2006 (JP) 2006-028916

(51) Int. Cl. H01R 13/15

(52) U.S. Cl. 439/260

(57) ABSTRACT

The present invention provides a connector fitting structure which includes a waterproof connector in which a female terminals having a plurality of sizes is arranged in a female connector housing thereof, and an opposite connector in which male terminals are arranged in a male connector housing thereof, wherein an area where a terminal having a high current-carrying capacity is arranged is formed as a projected surface relative to an area where terminals having a low current-carrying capacity low-current are arranged, and in a contact surface of the opposite connector, an area where the terminal having a high current-carrying capacity is arranged is formed as a depressed surface relative to an area where terminals having a low-current-carrying capacity low-current are arranged.

### BACKGROUND OF THE INVENTION

1. Field of the Invention

Present invention relates to a connector which accommodates terminals in a plurality of sizes with different current-carrying capacities, and a fitting structure of the connector.

2. Description of the Related Art

A connector includes a connector housing in which a plurality of terminals are arranged, and this connector housing is fitted into a connector housing of an opposite connector. Then, contact surfaces of the connector housings on both sides come into contact with each other, and male terminals are projected into the contact surface of the opposite connector, allowing the terminals on both sides are connected to each other. In a connector having this type of structure, it is necessary to ensure a creeping distance between neighboring terminals on the contact surfaces on both sides. Therefore, the plurality of terminals is arranged at a given pitch.

Meanwhile, a connector used for an automobile, is often used for connecting circuits in which various electric currents are flowing. For instance, current values are quite different among a power supply circuit (high-current circuit) to electric equipment, a switching circuit (medium-current circuit) to a relay or the like, and a signal circuit (low-current circuit) to a sensor, a drive computer, or the like. Therefore, depending on the current value, a plurality of terminals in different sizes and current-carrying capacities—a high-current terminal having high current-carrying capacity, a medium-current terminal having medium current-carrying capacity, and a low-current terminal having low current-carrying capacity—are used. In a connector in which these terminals in different sizes are provided together, terminals in the same size are arranged together to achieve a compact-sized connector while ensuring a predetermined creeping distance between the terminals. FIG. 1 shows an example of a conventional connector disclosed in Japanese Patent Laid-Open Publication No. 2002-164109, wherein terminals in the same size are arranged together.

In FIG. 1, a connector 100 includes a plurality of high-current male terminals 101a and a plurality of low-current male terminals 101b, and the high-current male terminals 101a are put together in a center area E1 of a contact surface 102 in a front view, and the low-current male terminals 101b are put together in upper and lower areas E2 and E3, respectively, of the center area E1.

However, as shown in FIG. 2, a pitch between the high-current male terminal 101a and the low-current male terminal 101b needs to be set at a predetermined creeping distance (3L: L represents an arbitrary coefficient, same for L hereafter) so that an insulation distance can be ensured between terminals, and ensuring this large pitch between terminals increases the size of the connector 100. Note that, in FIGS. 2 and 3, reference numeral 110 represents a contact surface of an opposite connector, reference numeral 111a represents a high-current female terminal, and reference numeral 111b represents a low-current female terminal.

Here, as shown in FIG. 3, a predetermined creeping distance (3 L) can be ensured between the high-current terminal 101a and the low-current terminal 101b by providing the contact surface 102 with a projection 103 and a groove 104 (refer to Japanese Patent Laid-Open Publication No. 7-65891 and Japanese Patent Laid-Open Publication No. 9-232027). In this method, a pitch between the high-current terminal 101a and a low-current terminal 101b simply needs to be set at 2L, and the connector 100 can be compact.

However, if the projection 103 and the groove 104 are provided between the high-current terminal 101a and the low-current terminal 101b, the widths of the projection 103 and the groove 104 become extremely small. Molds used for such molding articles are required to be durable against injection pressure during a forming process, and since there are restrictions such as a minimum thickness for the projection 103 and the groove 104, molds are put under a large strain.

### SUMMARY OF THE INVENTION

The present invention has been achieved to solve the above-described problems, and an objective thereof is to provide a connector and a connector fitting structure that includes terminals in a plurality of sizes with different current-carrying capacities, that is compact while ensuring a predetermined creeping distance between terminals in a plurality of sizes, and that does not strain a mold used in a forming process thereof.

The first aspect of the present invention is to provide a connector comprising: a connector housing having a contact surface to contact with another contact surface of a corresponding connector housing; and the contact surface including: a first area in which a terminal having a high current-carrying capacity is arranged; a second area in which a terminal having a low current-carrying capacity is arranged; and wherein the first area is formed as a projected or depressed surface against the second area so that there is a difference in elevation thereof. Additionally, sizes of both terminals may be different in accordance with the current-carrying capacities.

According to the above construction, even if a pitch between the terminal having a high current-carrying capacity and the terminal having a low current-carrying capacity is small, a difference in elevation made by the projected or depressed surface ensures a predetermined creeping distance. Further, since the contact surfaces can be formed by simply molding the area for the terminal having a high current-carrying capacity as a projected or depressed surface, there will be no strain on a mold. Therefore, it becomes possible to provide a connector which includes terminals with a plurality of sizes with different current-carrying capacities, and can be made into a compact size while ensuring a predetermined creeping distance between terminals in different sizes. Moreover, this connector does not strain a mold while being formed.

In addition to the foregoing construction, the terminal having a high current-carrying capacity may be located in a center area of the contact surface, and the center area of the contact surface may be formed as the projected or depressed surface.

According to the above construction, when the connector is mounted on a mounting surface or the like with facing down the contact surface, the projected surface in the center prevents the entire contact surface from being in contact with the mounting surface. Therefore, contamination of the contact surface and the terminals with dust and the like can be reduced.

The second aspect of the present invention is to provide A connector fitting structure in which a first connector housing provided with a plurality of male terminals having several current-carrying capacities, fits to a second connector housing provided with a plurality of female terminals having several current-carrying capacities correspondingly engaged with the male terminals, comprising: a first contact surface provided in the first connector housing; and a second contact surface provided in the second connector housing, contacting to the first contact surface with fitting of the first connector housing and the second connector housing each other; wherein both contact surfaces include a first area, in which the male and female terminals having a high current-carrying capacity are located, and a second area in which the male and female terminals having a low current-carrying capacity are located, and the first area is formed as a projecting or a depressed surface with respect to the second area.

According to the above construction, between the terminal having a high current-carrying capacity and the terminal having a low current-carrying capacity, a predetermined creeping is ensured even if a pitch between the terminals is small. Further, since the contact surfaces can be formed by simply molding the area for the terminal having a high current-carrying capacity as a projected or depressed surface, there will be no strain on a mold. Therefore, it becomes possible to provide a connector which includes terminals with a plurality of sizes with different current-carrying capacities, and can be made into a compact size while ensuring a predetermined creeping distance between terminals in different sizes. Moreover, this connector does not strain a mold while being formed.

### BRIEF DESCRIPTION OF THE DRAWINGS

FIG. 1 is a view showing a contact surface of a conventional connector.

FIG. 2 is a cross-sectional view showing a pitch between terminals in a conventional connector.

FIG. 3 is a cross-sectional view showing a pitch between terminals made in another method in a conventional connector.

FIG. 4 is a perspective view showing a waterproof connector according to a first embodiment of the present invention.

FIG. 5 is a perspective view showing an opposite connector being fitted to the connector according to the first embodiment of the present invention.

FIG. 6 is a cross-sectional view showing a state before the waterproof connector and the opposite connector are fitted to each other.

FIG. 7 is a cross-sectional view showing a state where the waterproof connector and the opposite connector are fitted to each other.

FIG. 8 is an enlarged cross-sectional view of a projected surface and a depressed surface on a contact surface according to the first embodiment of the present invention.

FIG. 9A is a schematic view showing a state where the waterproof connector according to the embodiment is mounted on a mounting surface, and FIG. 9B is a schematic view showing a state where a conventional connector is mounted on a mounting surface.

FIG. 10 is a conceptual view of a waterproof connector designed to incorporate a front holder.

FIG. 11 is an enlarged view of main portions of a modified example of the waterproof connector and the opposite connector.

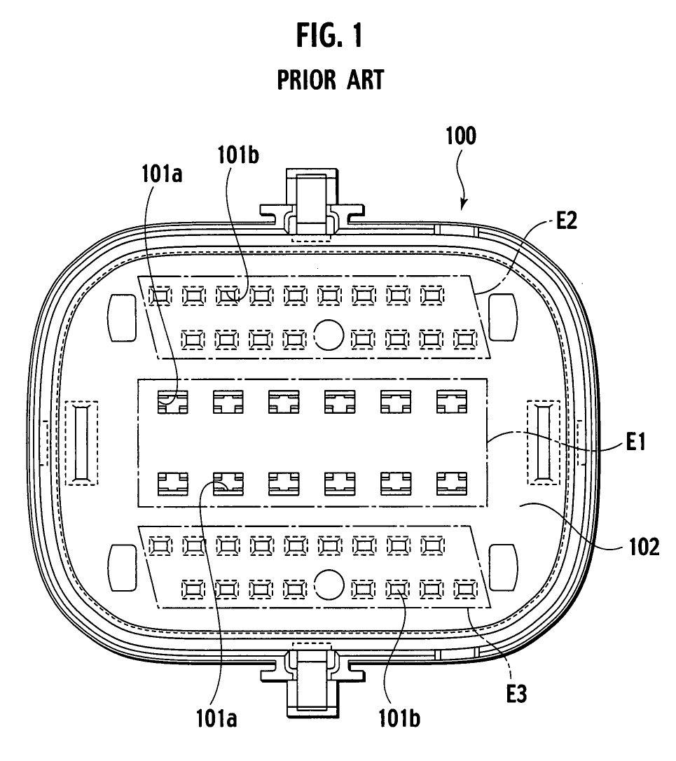

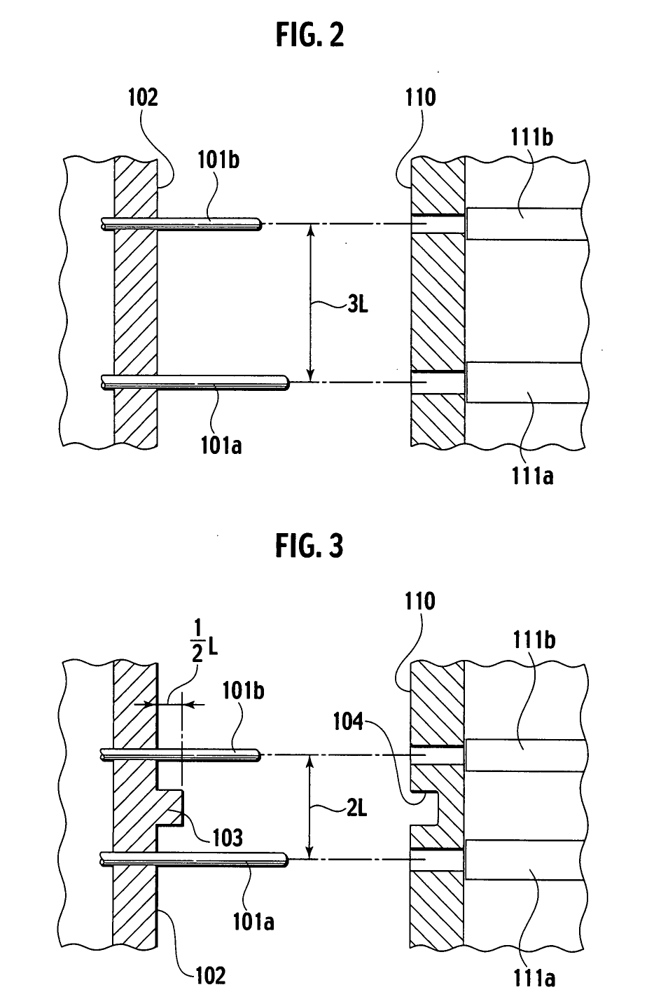

### DESCRIPTION OF THE EMBODIMENT

An embodiment of the present invention is described below based on the accompanied drawings in which a connector is used as a waterproof connector.

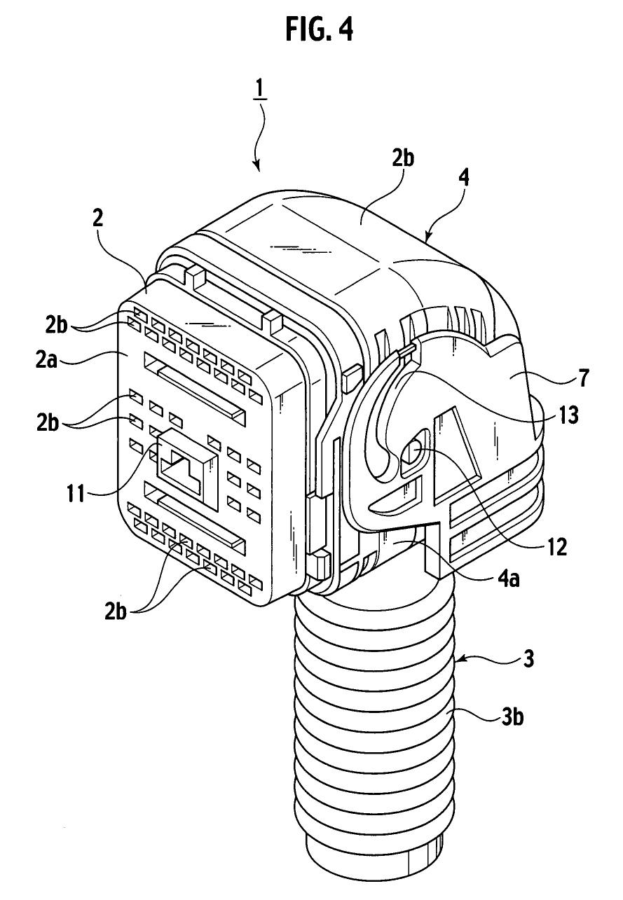

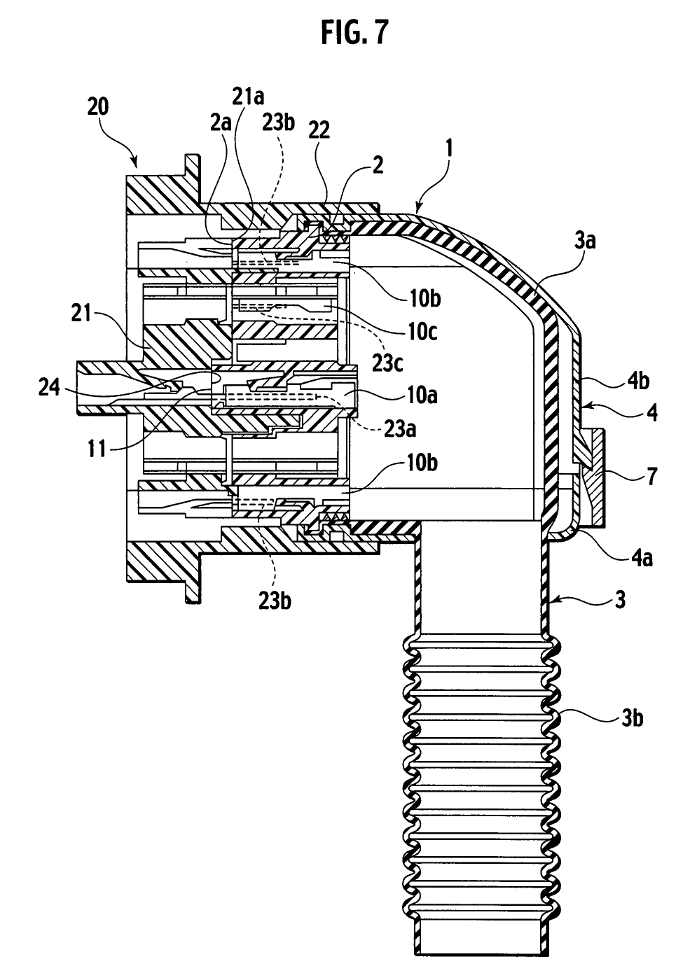

As shown in FIGS. 4, 5, 6 and 7, a connector is composed of a waterproof connector 1 as connector on one side, and an opposite connector 20 as a connector on the other side, which is to be fitted to the waterproof connector 1.

The waterproof connector 1 is provided with a female connector housing 2 fitting to the opposite connector 20, a grommet 3 attached to a cable lead-out side of the female connector housing 2 to cover cables (not shown) led out from the female connector housing 2, a grommet cover 4 attached to the grommet 3 on the outer circumference of the grommet 3, and an operation lever 7 swingably supported by the grommet cover 4.

The female connector housing 2 is formed by a hard synthetic resin material. In the female connector housing 2, female terminals 10a, 10b, and 10c having difference sizes are arranged, to which end portions of the cables (not shown) are connected, respectively. These female terminals 10a, 10b, and 10c include a high current female terminal 10a that is used for wiring a circuit requiring a high current (for example, a power supply circuit to electric equipment), medium-current female terminals 10b that are used for wiring a circuit requiring a low current (for example, a switching circuit to a relay or the like), and low-current female terminals 10c that are used for wiring a circuit requiring an even lower current (for example, a signal circuit to a sensor, a drive computer, or the like).

In a contact surface 2a of the female connector housing 2, a number of terminal insertion holes 2b are made at locations facing the female terminals 10a, 10b, and 10b, respectively. The terminal insertion hole 2b for the high-current female terminal 10a is arranged in a center area of the contact surface 2a, and the center area of the contact surface 2a is formed as a projected surface 11 which is higher than the surrounding area.

The grommet 3 is formed by an elastic rubber material or an elastomeric material. The grommet 3 includes a grommet body portion 3a formed into a cap shape with a front surface open, and a cylindrical portion 3b for cable protection, one end of which is fixed to the grommet body portion 3a. The cables (not shown) led out from the female connector housing 2 are brought out through the grommet body portion 3a and the cylindrical portion 3b for cable protection.

The grommet cover 4 includes a pair of divided cover members 4a and 4b, each formed by a hard synthetic resin material. The pair of divided cover members 4a and 4b is attached, sandwiching the external sides of the grommet body portion 3a. Also, on the right and left sides of one of the divided cover members 4b, a pair of support pins 12 is projected.

The operation lever 7 is swingably supported along the outer boundary of the grommet cover 4 about the pair of support pins 12 of the divided cover member 4b. On the right and left sides of the operation lever 7, cam grooves 13 are formed.

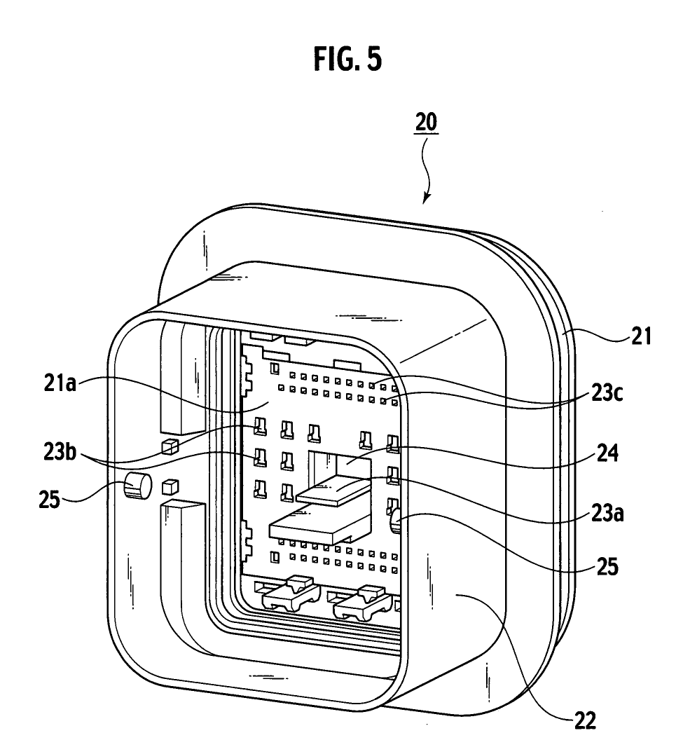

Meanwhile, as shown in FIGS. 5, 6 and 7, the opposite connector 20 includes a male connector housing 21, and a connector hood 22 which is provided along the entire circumference of the male connector housing 21 and projected to the front side of a contact surface 21a.

The male connector housing 21 is formed by a hard synthetic resin material. In the male connector housing 21, male terminals 23a, 23b, and 23c having a plurality of sizes are arranged, to which ends of cables (not shown) are connected, respectively. These male terminals 23a, 23b, and 23c correspond to the aforementioned female terminals 10a, 10b, and 10c, respectively, and include a high-current male terminal 23a that is used for wiring a circuit requiring a high current (for example, a power supply circuit to electric equipment), medium-current male terminals 23b that are used for wiring a circuit requiring a low current (for example, switching circuit to a relay or the like), and low-current male terminals 23c that are used for wiring a circuit requiring an even lower current (for example, a signal circuit to a sensor, a drive computer, or the like).

In the contact surface 21a of the male connector housing 22, end portions of the male terminals 23a, 23b, and 23c are projected. The projected portion of the high-current male terminal 23a is located in a center area of the contact surface 21a, and the center area in the contact surface 21a is formed in a depressed surface 24 which is one step lower than the surrounding area.

On both sides of the inner wall of the connector hood 22, cam pins 25 are projected.

In the above-described structure, when, for example, a wire harness is routed between an engine room and a cabin, the waterproof connector 1 is connected to an end portion of the wire harness routed on the side of the engine room which is more likely to be submerged. The opposite connector 20 is connected to an end portion of the wire harness routed on the side of the cabin which is very unlikely to be submerged. The opposite connector 20 is fixed from the cabin side to an instrument panel that serves as a partition between the engine room and the cabin. Thereafter, the waterproof connector 1 is fitted to the opposite connector 20 from the engine-room side of the instrument panel.

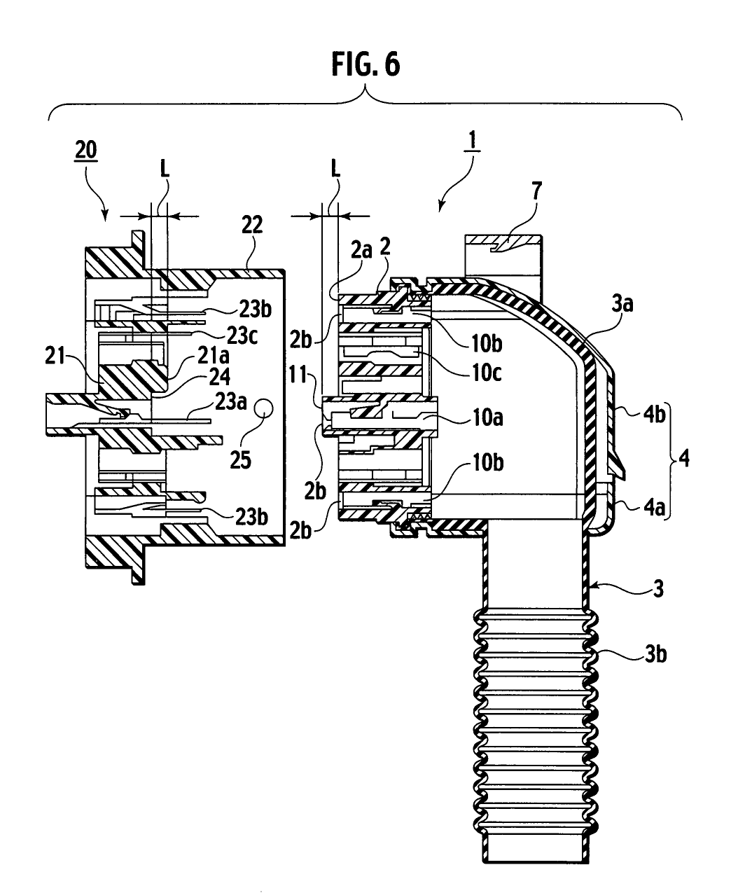

A fitting operation of the waterproof connector 1 to the opposite connector 20 is explained below with reference to FIG. 6. The waterproof connector 1 is positioned so that the contact surfaces 2a and 21a on both sides are faced to each other. The cam pins 25 on the connector hood 22 of the opposite connector 20 are inserted into the cam grooves 13 in the operation lever 7 of the waterproof connector 1. Next, the operation lever 7 is rotated. As the operation lever 7 rotates, the cam pins 25 are guided along the cam grooves 13 of the operation lever 7, and the waterproof connector 1 is gradually pulled toward the opposite connector 20. Once the operation lever 7 is rotated to the position where the operation is completed, the connectors 1 and 20 on both sides are completely fitted to each other. In other words, the contact surfaces 2a and 21a on both sides come into contact with each other, and the male terminals 23a, 23b, and 23c in different sizes are electrically connected to the corresponding female terminals 10a, 10b and 10c with corresponding sizes, respectively.

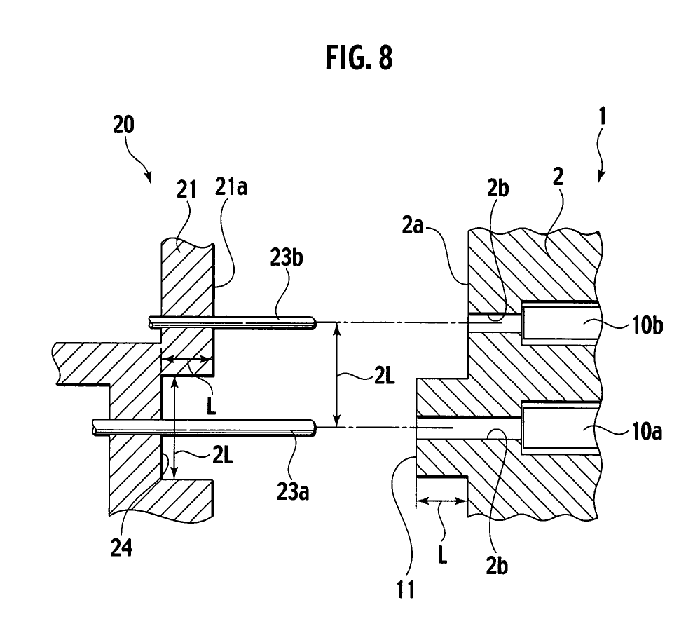

In this connector fitting structure, even if a pitch between the high-current male terminal 23a and the medium-current male terminal 23b is small, a predetermined creeping distance is ensured because of a difference in elevation made by the projected surface 11 and the depressed surface 24. To be more specific, as shown in FIG. 8, when a predetermined creeping distance between the high-current male terminal 23a and the medium-current male terminal 23b is 3L, the predetermined creeping distance can be ensured if a dimension of the difference in elevation of the projected surface 11 and the depressed surface 24 from the surround areas is set at L even if the pitch between the terminals is 2L.

Further, for molding of the contact surfaces 2a and 21a, the areas for male and female high-current terminals 10a and 23a are simply formed as the projected surface 11 and the depressed surface 24, which does not cause a strain on molds. As a result, the waterproof connector 1 and the opposite connector 20 can be provided, each of which includes the terminals 10a, 10b, and 10c (or 23a, 23b, and 23c) with a plurality of sizes and different current-carrying capacities, which can be made into a compact size while ensuring a predetermined creeping distance between terminals in a plurality of sizes. Moreover, these connectors do not strain molds during a forming process thereof.

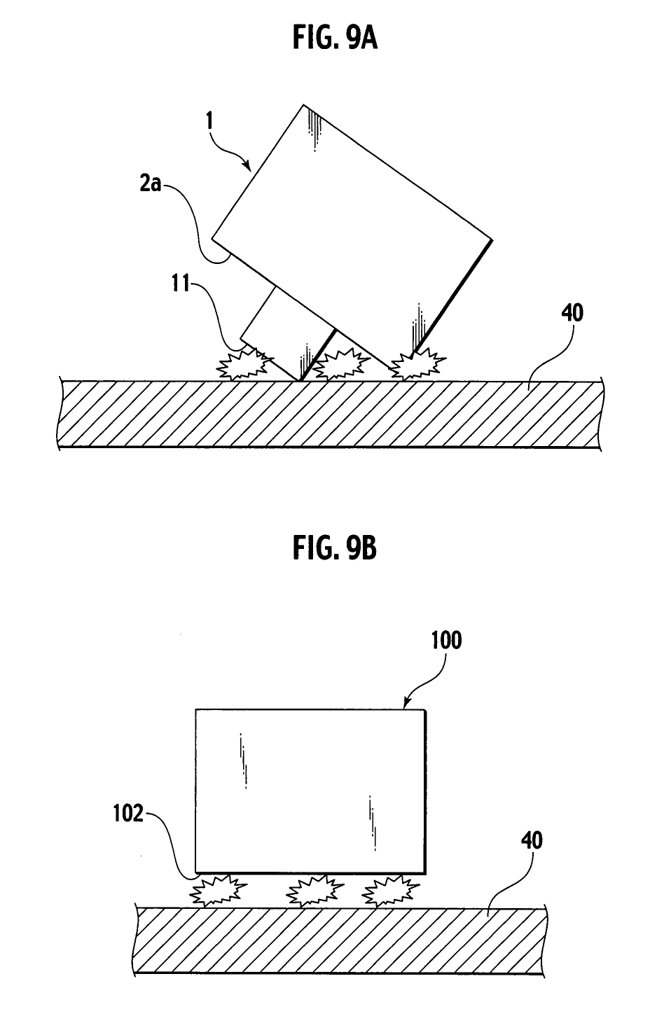

Furthermore, as shown in FIG. 9B, if the connector 100 of the conventional connector is mounted on a mounting surface 40 such as a floor, with facing down the contact surface 102 thereof, the entire surface of the contact surface 102 comes into contact with the mounting surface 40, it is highly likely that dusts and the like could contaminate the contact surface 102 or the female terminals. On the other hand, as shown in FIG. 9A, in this embodiment, when the waterproof connector 1 is mounted on the mounting surface 40 with facing down the contact surface 2a, the contact surface 2a is prevented from coming into fully contact with the mounting surface 40 by the projected surface 11 formed at the center. Hence, contamination of the contact surface 2a and female terminals 10a, 10b and 10c due to dust and the like can be reduced without covering the contact surface 2a with a hood or the circumference portion of the connector.

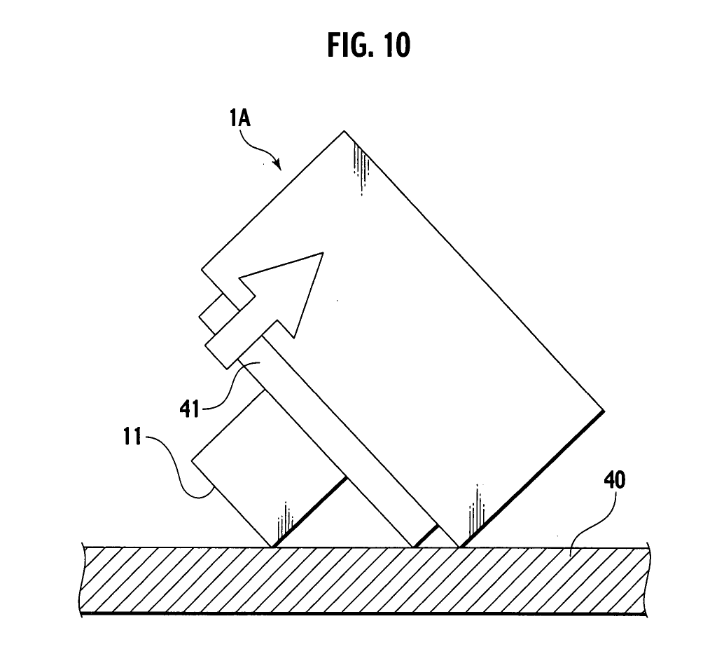

FIG. 10 is a schematic view of a waterproof connector 1A designed to incorporate a front holder 41. The front holder 41 enforces engagement of the terminals and connector housings when the connectors are fitted to each other. With this design, when the front holder 41 is temporarily engaged, even if the connector 1A is mounted on the mounting surface 40 with facing down a contact surface 2a thereof, the front holder 41 is moved in the arrow direction, preventing the front holder 41 from being fully engaged.

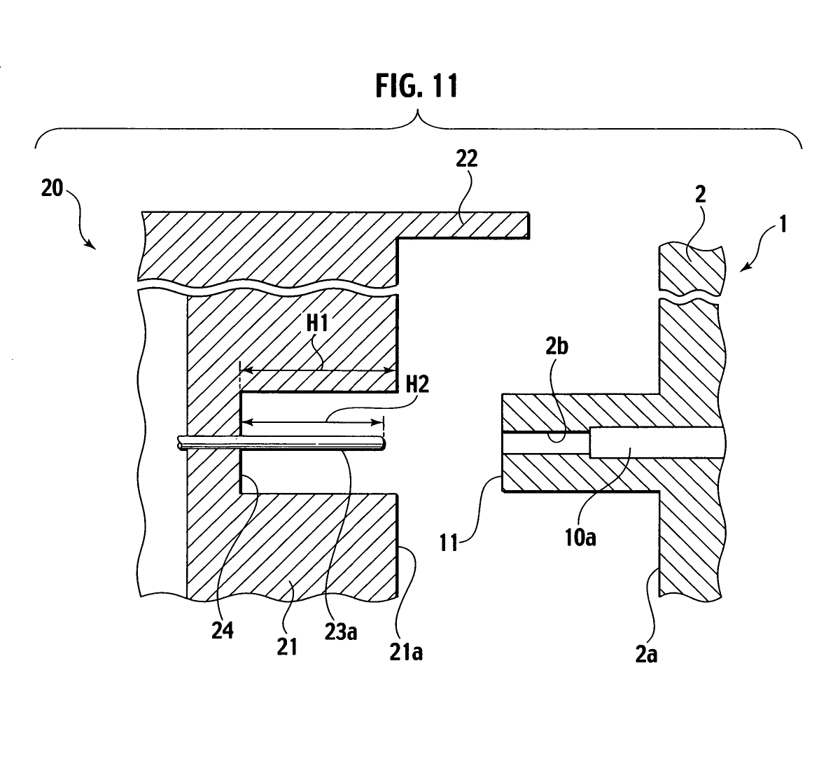

FIG. 11 is an enlarged view of main portions of a waterproof connector 1 and an opposite connector 20 in a modification example. As shown in this drawing, a depressed surface 24 of a contact surface 20a of an opposite connector 20 is made so that a dimension of an elevation difference H1 of the depression is larger than a dimension of the projection H2 of a high-current male terminal 23a. A projected surface 11 of a contact surface 2a of the waterproof connector 1 is also designed so that a dimension of an elevation difference corresponds to H1. With this design, when the connectors are fitted to each other, the projected surface 11 of the waterproof connector 1 first comes to contact with the entrance of the depressed portion of the depressed surface 24 of the opposite connector, and then the projected surface 11 is inserted into the depressed portion of the depressed surface 24. In this process of insertion, as the high-current male terminal 23a starts to be inserted into the terminal insertion hole 2b, insertion of the female connector housing 2 into the connector hood 22 begins. This means that, when the high-current male terminal 23a is inserted to the terminal insertion hole 2b and when the female connector housing 2 is inserted to the connector hood 22, the projected surface 11 and the depressed surface 24 work as a guide, and therefore the insertion is carried out smoothly.

In the above-described embodiment, the female terminals 10a, 10b, and 10c are provided in the waterproof connector 1, and the male terminals 23a, 23b, and 23c are provided in the opposite connector 20. However, instead, the male terminals 23a, 23b, and 23c may be provided in the waterproof connector 1, and the female terminals 10a, 10b, and 10c may be provided in the opposite connector 20. The contact surface 2a of the waterproof connector 1 is provided with the projected surface 11, and the contact surface 21a of the opposite connector 20 is provided with the depressed surface 24. However, instead, the depressed surface 24 may be provided in the contact surface 2a of the waterproof connector 1, and the projected surface 11 may be provided in the contact surface 21 a of the opposite connector 20.

Note that, in this embodiment, the waterproof connector 1 (or the opposite connector 20) which includes terminals in three sizes, the high-current female terminal 10a and the medium-current female terminals 10b, and low-current female terminals 10c, is described. However, it should be apparent that the present invention can be similarly applied to a connector which includes terminals with two different sizes, or four or more different sizes.

What is claimed is:

1. A connector comprising:
a connector housing having a contact surface to contact with another contact surface of a corresponding connector housing;
wherein the contact surface includes a first area in which a terminal having a high current-carrying capacity is arranged, and a second area in which a terminal having a low current-carrying capacity is arranged; and
wherein the first area is formed as a projected or depressed surface against the second area so that there is a difference in elevation thereof.

2. The connector according to claim 1,
wherein the first area is located in a center of the contact surface.

3. The connector according to claim 1,
wherein sizes of both terminals are different in accordance with the current-carrying capacities.

4. A connector fitting structure in which a first connector housing provided with a plurality of male terminals having several current-carrying capacities, fits to a second connector housing provided with a plurality of female terminals having several current-carrying capacities correspondingly engaged with the male terminals, comprising:
a first contact surface provided in the first connector housing; and
a second contact surface provided in the second connector housing, contacting to the first contact surface with fitting of the first connector housing and the second connector housing each other;
wherein both contact surfaces include a first area, in which the male and female terminals having a high current-carrying capacity are located, and a second area, in which the male and female terminals having a low current-carrying capacity are located, and the first area is formed as a projecting or a depressed surface with respect to the second area.

5. The connector fitting structure according to claim 4, wherein the first area is formed in a center of both contact surfaces.
